(19) United States
(12) Patent Application Publication
(10) Pub. No.: US 2020/0130022 A1
(43) Pub. Date: Apr. 30, 2020

(54) NC-based ring blade production apparatus

(71) Applicant: Juanying Tong, Taizhou City (CN)

(72) Inventor: Juanying Tong, Taizhou City (CN)

(21) Appl. No.: 16/726,960

(22) Filed: Dec. 26, 2019

(30) Foreign Application Priority Data
Aug. 27, 2019 (CN) 2019107979913

(51) Int. Cl. B08B 3/02; B08B 3/12

(52) U.S. Cl. CPC B08B 3/022; B08B 2203/0211; B08B 3/12

(57) ABSTRACT

An ultrasonic electronic component cleaning apparatus disclosed by the present invention includes the cleaning box, the cleaning box is provided with a cleaning chamber, a cover chamber is provided in the top wall of the cleaning box, and the top wall of the cover chamber is provided in the cleaning box. A cover mechanism is provided symmetrically, and a lifting cavity is communicated in the lower wall of the cleaning cavity. The invention has a simple structure, convenient maintenance and convenient use. The components are cleaned in all directions without dead ends, which greatly improves the cleaning efficiency and the cleaning effect. At the same time, it will not have any negative impact on the electronic components, which is worthy of industrial promotion.

### CROSS-REFERENCES TO RELATED APPLICATIONS

The present application claims priority from Chinese application No. 2019107979913 filed on Aug. 27, 2019 which is hereby incorporated by reference in its entirety.

### FIELD OF TECHNOLOGY

The invention relates to the field of electronic component cleaning, and in particular relates to a ultrasonic electronic component cleaning apparatus.

### TECHNICAL FIELD

Electronic components are the basic components of electronic products, and impurities, dirt, and residual waste are adsorbed on the surface of electronic components during the manufacturing process. Therefore, electronic components need to be cleaned. However, existing electronic component cleaning devices mainly The electronic components are completely immersed in the cleaning agent and brushed with mechanical devices. In this way, it is difficult to remove the small impurities hidden inside the components, which leads to poor cleaning results, and requires repeated repeated cleaning, which is inefficient, so it needs to be developed. An efficient electronic component cleaning device, which can better clean electronic components by ultrasonic cleaning.

### CONTENT OF THE INVENTION

Technical problem: It is difficult for the existing electronic component cleaning device to remove the small impurities hidden inside the component, the cleaning effect is not good, and repeated cleaning is required many times, which is inefficient.

In order to solve the above problems, an ultrasonic electronic component cleaning device is designed in this example. An ultrasonic electronic component cleaning device in this example includes the cleaning box, and a cleaning chamber is provided in the cleaning box. Cleaning is performed in the cleaning chamber. A cover chamber is provided in the top wall of the cleaning box, and a cover mechanism is symmetrically arranged in the top wall of the cover chamber. The cover mechanism can open or close the cleaning. A lifting chamber is communicated in the lower wall of the cleaning chamber. The lifting chamber is provided with a lifting mechanism. The lifting mechanism can carry electronic components. The lifting mechanism can slide up and down in the cleaning chamber, which is convenient. An operator picks and places electronic components. A spraying mechanism is provided in the left wall of the lifting chamber. The spraying mechanism can spray cleaning agents on electronic components placed in the cleaning chamber. A power chamber is provided in the right wall of the lifting chamber. A power mechanism is provided in the power chamber, a transmission chamber is provided in the lower wall of the power chamber, and a transmission mechanism is provided in the transmission chamber. The transmission mechanism is connected to the power mechanism, and then the power mechanism To drive the transmission mechanism, a drainage pipe is provided in the left wall of the cleaning box, and the right end of the drainage pipe is in communication with the lifting chamber, so that the cleaning agent in the lifting chamber and the cleaning chamber can pass through the drainage pipe. Discharged to the outside of the device, a drainage control cavity is provided in the lower wall of the cleaning box, and a drainage control mechanism is provided in the drainage control cavity. The drainage control mechanism can control the opening and closing of the drainage pipe. The drainage control mechanism The right end is connected to the transmission mechanism, and the right end of the lifting mechanism is connected to the transmission mechanism. The transmission mechanism can drive the drainage control mechanism and the transmission mechanism. An ultrasonic mechanism cavity is provided in the upper wall of the power cavity. An ultrasonic mechanism is arranged in the cavity of the ultrasonic mechanism, and the ultrasonic mechanism can emit ultrasonic waves, so that the cleaning agent in the cleaning cavity vibrates, and then the electronic components can be ultrasonically cleaned.

The cover mechanism includes a first motor fixedly installed in the cover cavity, and a first power shaft is dynamically connected to one end of the first motor near the cleaning cavity, and the first power shaft is close to the A first bevel gear is fixed at one end of the cleaning cavity, and a second bevel gear is meshed with the first bevel gear. A first positioning shaft is fixed on the center of the second bevel gear. A rotatable first link is fixed on the first positioning shaft, and a rotatable second positioning shaft is provided on the lower end of the first link. A large slider is fixed on the second positioning shaft, and a rotatable second link is provided in the cover cavity, and the second link is hinged in the lower wall of the cover cavity through a third positioning shaft. The large slider can slide in the second link, a third link is provided at the upper end of the second link, and the third link is connected to the upper end of the second link through a fourth positioning shaft Hinged, a cover plate is provided at one end of the third link near the center of the device, and the cover plate is hinged with the third link through a fifth positioning axis, When the first motor is started, the first motor drives the first power shaft to rotate, and the first power shaft drives the first positioning shaft to rotate through the first bevel gear and the second bevel gear The first positioning shaft drives the first link to rotate, and the first link further drives the large slider to slide in the second link through the second positioning shaft, thereby making the A second link rotates around the third positioning axis, and the second link drives the cover plate to slide left and right through the fourth positioning axis, the third link, and the fifth positioning axis, thereby further enabling The cleaning chamber is opened or closed.

Wherein, the spraying mechanism includes a high-pressure pump fixedly located in the left wall of the cleaning tank, a first pipe is connected to the left end of the high-pressure pump, and a cleaning agent storage chamber is connected to the lower end of the first pipe. A cleaning agent can be stored in the cleaning agent storage chamber. A second pipe is connected to the right end of the high-pressure pump, and a high-pressure valve is symmetrically arranged on the right end. When the high-pressure pump is started, the high-pressure pump can connect the high-pressure pump. The cleaning agent in the cleaning agent storage chamber is pumped into the high pressure valve through the first pipeline and the second pipeline, so that the high pressure valve can spray the cleaning agent into the cleaning chamber.

Advantageously, a high-pressure pipeline is provided in the high-pressure valve, and the left end of the high-pressure pipeline is in communication with the second pipeline. A slider cavity is provided in the high-pressure valve, and a high pressure is fixed on the left wall of the slider cavity. A high-pressure valve spring is fixed to the right end of the high-pressure valve electromagnet, and a high-pressure valve slider is fixed to the right end of the high-pressure valve spring. A small pipeline is provided in the high-pressure valve slider. It can slide left and right in the slider cavity. When the high-pressure valve electromagnet is activated, the high-pressure valve electromagnet can generate suction and attract the high-pressure valve slider to slide to the left, so that the small pipeline and the high pressure The pipes are docked, and the cleaning agent can flow into the small pipe through the second pipe and the high-pressure pipe, and spray into the cleaning chamber through the small pipe.

Wherein, the power mechanism includes a second motor fixedly installed in the upper wall of the power cavity, a second power shaft is power-connected to the second motor, and a lower end of the second power shaft is sleeved to slide up and down The hollow shaft is splined to the second power shaft, a sliding gear is fixed on the hollow shaft, and a magnetic slider capable of sliding up and down is connected to the left end of the sliding gear. A connecting spring is fixed at the upper end of the slider, an electromagnet is fixed at the upper end of the connecting spring, a first connecting gear is fixed at the lower end of the hollow shaft, and a first transmission shaft is rotatably provided in the lower wall of the power chamber. A second connection gear is fixed on the first transmission shaft, and the second connection gear can be meshed with the first connection gear. When the second motor is started, the second motor drives the second motor. The power shaft rotates, the second power shaft drives the hollow shaft to rotate, and the hollow shaft drives the sliding gear and the first connecting gear to rotate. At this time, the electromagnet is energized, and the electromagnet repels Mentioned magnetic slider, so that all The magnetic slider slides downward, the magnetic slider drives the sliding gear to slide downward, so that the sliding gear drives the hollow shaft and the first connecting gear to slide downward, and the first connecting gear and the The second connecting gear meshes, and the first connecting gear can drive the first transmission shaft to rotate through the second connecting gear.

Wherein, the transmission mechanism includes a first transmission gear provided in the transmission cavity, the first transmission gear axis is fixed on the first transmission shaft, and the lower end of the first transmission gear is meshed and connected with A second transmission gear, the left end of the second transmission gear is connected to the lifting mechanism, and when the first transmission shaft rotates, the first transmission shaft can be connected by the first transmission gear and the second transmission gear Driving the lifting mechanism, a third transmission gear is fixed at the lower end of the first transmission shaft, a fourth transmission gear is engaged with the lower end of the third transmission gear, and a second transmission shaft is fixed at the center of the fourth transmission gear. A transmission shaft, the second transmission shaft is rotatably provided in the front and rear walls of the transmission cavity, a first belt pulley is fixed on the second transmission shaft, and a first belt is connected to the first belt pulley. The left end of the first belt is connected to the drainage control mechanism. When the first transmission shaft rotates, the first transmission shaft drives the second transmission shaft through the third transmission gear and the fourth transmission gear. Turn, the second pass Said first shaft by a first belt pulley and the control means may drive the drain

Wherein, the lifting mechanism includes rotatable screws provided in the left and right walls of the lifting cavity, the screws are provided with a set of threads with opposite rotation directions, and the screws are provided with slidable screw slides symmetrically on the left and right sides. Block, the screw slider is connected with the screw by a screw, the upper end of the screw slider is provided with a rotatable central link, and the lower end of the central link is hinged with the screw slider through a first hinge shaft, so A support slider is provided symmetrically in the lifting cavity, the support slider and the top of the central link are hinged by a second hinge axis, and the central link is hinged by a third hinge axis. A rotatable pulley shaft is symmetrically arranged on the block. The pulley shaft is fixed with a pulley. The upper end of the pulley is provided with a bearing plate. The bearing plate can carry electronic components. When the screw rotates, The screw slider can be driven to slide toward and away from each other. The screw slider drives the central link to rotate through the first hinge shaft, and the central link drives the support slide through the second hinge shaft. Block in the lifting Sliding the support so as to drive the slide carrier plate up, or down through the pulley and the pulley shaft, in turn, may drive the electronic component up, or down.

Wherein, the drainage control mechanism includes a drainage shaft rotatably provided in the front and rear walls of the drainage control cavity, a second pulley is fixed on the drainage shaft, and the second pulley is connected to the left end of the first belt A drainage control gear is fixed on the drainage shaft, the drainage control gear is located at the rear end of the second pulley, a drainage baffle is meshed with the left end of the drainage control gear, and the drainage baffle can close the drainage baffle In the drainage pipe, when the first belt drives the drainage shaft to rotate through the second pulley, the drainage shaft drives the drainage control gear to rotate, and the drainage control gear drives the drainage baffle to slide downward, and then The drainage baffle can open the drainage pipe, so that the cleaning agent in the lifting chamber can flow out of the device through the drainage pipe.

Wherein, the ultrasonic mechanism includes a rotating shaft rotatably provided in the right wall of the cavity of the ultrasonic mechanism, a first gear is fixed on the rotating shaft, and a second gear is engaged with the lower end of the first gear, The lower end of the second gear is fixed on the second power shaft, an ultrasonic generator is fixed on the left end of the rotating shaft, and a resonance plate is fixed on the left end of the ultrasonic generator. When the second power shaft rotates, The second power shaft drives the rotating shaft to rotate through the second gear and the first gear, and the rotating shaft can drive the ultrasonic generator, and the ultrasonic generator can emit ultrasonic waves, thereby driving The resonance sheet vibrates, and the resonance sheet can further drive the cleaning agent to vibrate, so that the cleaning agent can perform ultrasonic cleaning on the electronic component.

The beneficial effects of the present invention are: the structure of the present invention is simple, the maintenance is convenient, and the use is convenient. The device uses an ultrasonic sounding device to enable the cleaning agent to perform all-round and dead-end cleaning of electronic components through high-frequency vibration, thereby greatly improving cleaning efficiency. Improve the cleaning effect, and will not have any negative impact on electronic components, it is worth industrialization promotion.

### BRIEF DESCRIPTION OF THE DRAWINGS

For ease of description, the present invention is described in detail by the following specific embodiments and the accompanying drawings.

FIG. 1 is a schematic diagram of the overall structure of an ultrasonic electronic component cleaning device according to the present invention;

FIG. 2 is an enlarged schematic view of the “A” structure of FIG. 1;

FIG. 3 is an enlarged schematic view of the “B” structure of FIG. 1;

FIG. 4 is an enlarged schematic view of the “C” structure of FIG. 1;

FIG. 5 is an enlarged schematic view of the “D” structure of FIG. 1;

FIG. 6 is an enlarged schematic view of the “E” structure of FIG. 3.

### DETAILED DESCRIPTION OF THE INVENTION

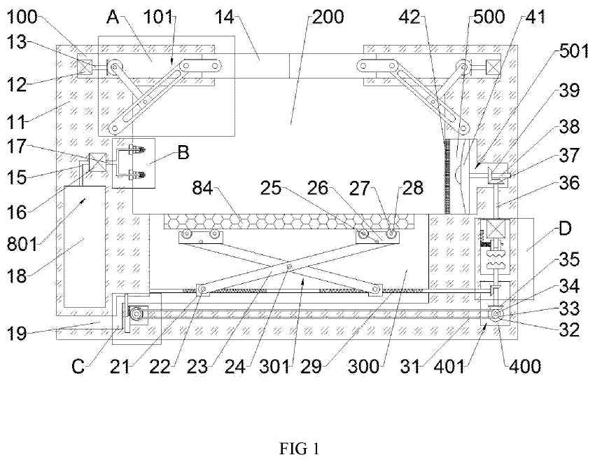

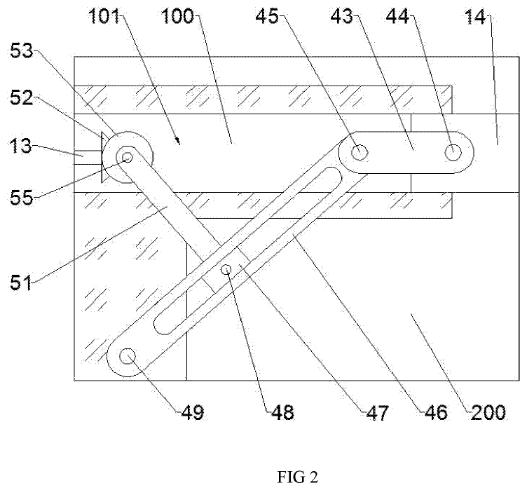

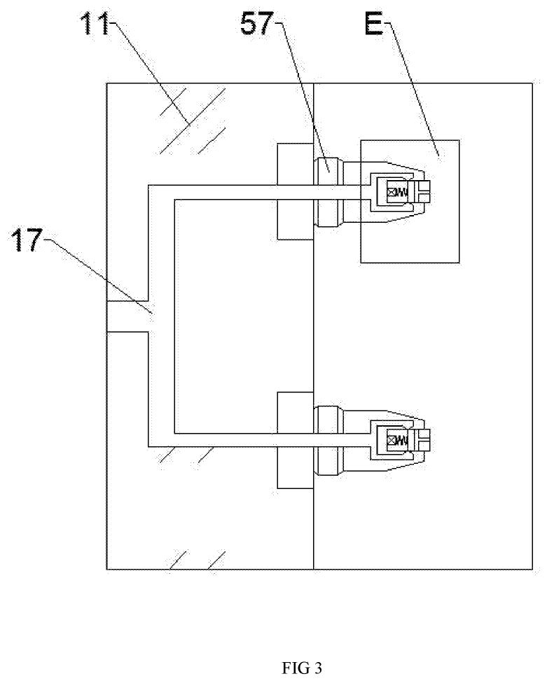

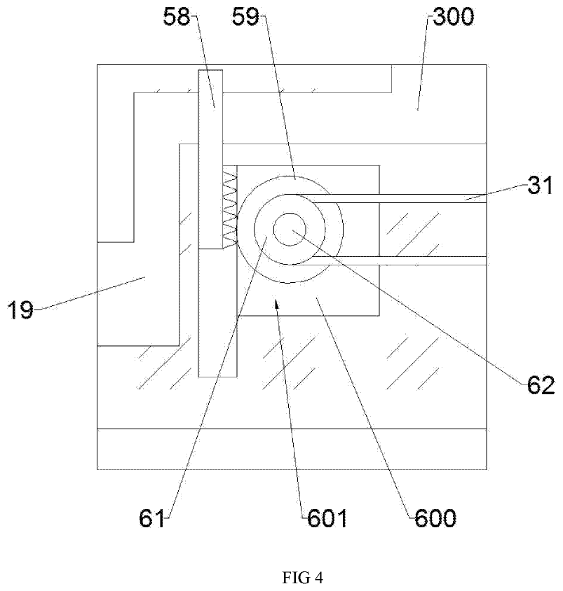

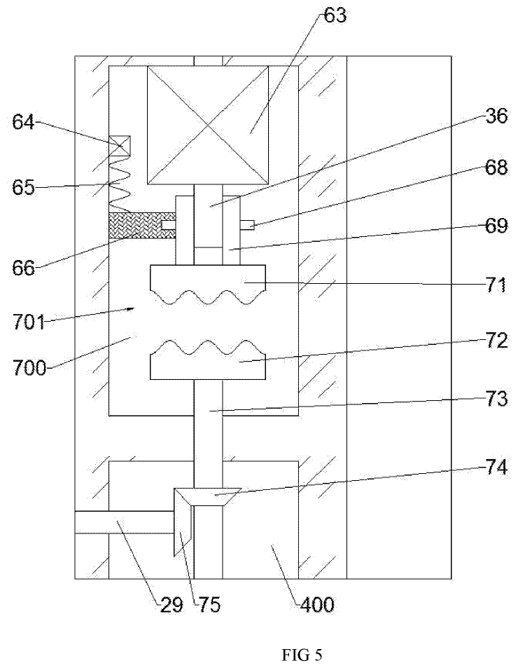

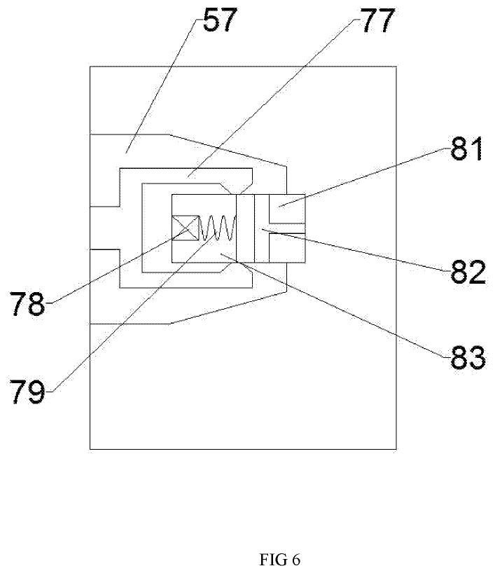

The present invention will be described in detail below with reference to FIGS. 1-6. For convenience of description, the orientation described below is defined as follows: the up-down, left-right, front-back direction described below is consistent with the up-down, left-right, front-back direction of the projection relationship of FIG. 1 itself.

The invention relates to an ultrasonic electronic component cleaning device, which is mainly used for ultrasonic cleaning of electronic components. The invention will be further described below with reference to the accompanying drawings of the invention:

The ultrasonic electronic component cleaning device according to the present invention includes the cleaning box 11. A cleaning chamber 200 is provided in the cleaning box 11. Electronic components can be cleaned in the cleaning chamber 200. 11 A cover plate cavity 100 is provided in the top wall, and a cover plate mechanism 101 is symmetrically formed in the top wall of the cover plate 100. The cover plate mechanism 101 can open or close the cleaning cavity 200, and the cleaning cavity. A lifting cavity 300 is communicated in the lower wall of 200. The lifting cavity 300 is provided with a lifting mechanism 301. The lifting mechanism 301 can carry electronic components. The lifting mechanism 301 can slide up and down in the cleaning cavity 200. It is convenient for the operator to pick and place electronic components. A spraying mechanism 801 is provided in the left wall of the lifting cavity 300, and the spraying mechanism 801 can spray cleaning agents on the electronic components placed in the cleaning cavity 200. A power chamber 700 is provided in the wall, and a power mechanism 701 is provided in the power chamber 700. A transmission chamber 400 is provided in the lower wall of the power chamber 700, and a transmission mechanism 401 is provided in the transmission chamber 400. 401 is connected to the power mechanism 701, and A power mechanism 701 can drive the transmission mechanism 401. A drainage pipe 19 is provided in the left wall of the cleaning tank 11, and the right end of the drainage pipe 19 is in communication with the lifting chamber 300, and then the lifting chamber 300 and the cleaning chamber The cleaning agent in 200 can be discharged to the outside of the device through the drainage pipe 19. A drainage control chamber 600 is provided in the lower wall of the cleaning tank 11, and a drainage control mechanism 601 is provided in the drainage control chamber 600. A mechanism 601 can control the opening and closing of the drainage pipe 19, a right end of the drainage control mechanism 601 is connected to the transmission mechanism 401, and a right end of the lifting mechanism 301 is connected to the transmission mechanism 401, so that the transmission mechanism 401 can drive In the drainage control mechanism 601 and the transmission mechanism 401, an ultrasonic mechanism cavity 500 is provided in the upper wall of the power chamber 700, and an ultrasonic mechanism 501 is provided in the ultrasonic mechanism cavity 500. The ultrasonic mechanism 501 can emit ultrasonic waves. The cleaning agent in the cleaning chamber 200 is vibrated, so that the electronic components can be ultrasonically cleaned.

According to an embodiment, the cover mechanism 101 is described in detail below. The cover mechanism 101 includes a first motor 12 fixed in the cover cavity 100, and the first motor 12 is close to the cleaning cavity. A first power shaft 13 is power-connected at one end of the first power shaft 13, and a first bevel gear 52 is fixed at one end of the first power shaft 13 near the cleaning cavity 200. A second bevel is meshed with the first bevel gear 52. A gear 53, the second bevel gear 53 is fixedly provided with a first positioning shaft 55, and the first positioning shaft 55 is rotatably provided in the front and rear walls of the cover cavity 100. The first positioning shaft 55 A rotatable first link 51 is fixedly mounted on the lower end of the first link 51 and a second positioning shaft 48 is rotatable. A large slider 47 is fixed on the second positioning shaft 48. The cover chamber 100 is provided with a rotatable second link 46, and the second link 46 is hinged in the lower wall of the cover chamber 100 through a third positioning shaft 49. The second link 46 slides inside, and a third link 43 is provided at an upper end of the second link 46. The third link 43 is connected to the second link 46 through a fourth positioning shaft 45. The third link 43 is provided with a cover plate 14 at one end near the center of the device. The cover plate 14 is hinged with the third link 43 through a fifth positioning shaft 44. When the first motor 12 is started, The first motor 12 drives the first power shaft 13 to rotate, and the first power shaft 13 drives the first positioning shaft 55 to rotate through the first bevel gear 52 and the second bevel gear 53. The first positioning shaft 55 drives the first link 51 to rotate, and the first link 51 drives the large slider 47 to slide in the second link 46 through the second positioning shaft 48. So that the second link 46 is rotated around the third positioning shaft 49, and the second link 46 passes the fourth positioning shaft 45, the third link 43, and the fifth positioning shaft 44 drives the cover plate 14 to slide left and right, so that the cleaning chamber 200 can be opened or closed.

According to an embodiment, the spraying mechanism 801 is described in detail below. The spraying mechanism 801 includes a high-pressure pump 16 fixedly located in the left wall of the cleaning tank 11, and a first pipeline is connected to the left end of the high-pressure pump 16. 15, the lower end of the first pipeline 15 is connected with a detergent storage cavity 18, and the detergent storage cavity 18 can store a detergent, and the right end of the high-pressure pump 16 is connected with a second pipeline 17, the right end A high-pressure valve 57 is symmetrically arranged vertically. When the high-pressure pump 16 is started, the high-pressure pump 16 can pass the detergent in the detergent storage chamber 18 through the first pipeline 15 and the second pipeline. 17 is pumped into the high pressure valve 57, so that the high pressure valve 57 can spray a cleaning agent into the cleaning chamber 200.

Advantageously, a high-pressure pipeline 77 is provided in the high-pressure valve 57, and the left end of the high-pressure pipeline 77 is in communication with the second pipeline 17. A slider cavity 83 is provided in the high-pressure valve 57. A high-pressure valve electromagnet 78 is fixed on the left wall of the cavity 83. A high-pressure valve spring 79 is fixed on the right end of the high-pressure valve electromagnet 78. A high-pressure valve slider 81 is fixed on the right end of the high-pressure valve spring 79. A small pipeline 82 is provided in 81. The high-pressure valve slider 81 can slide left and right in the slider cavity 83. When the high-pressure valve electromagnet 78 is activated, the high-pressure valve electromagnet 78 can generate suction and attract all The high-pressure valve slider 81 slides to the left, so that the small pipe 82 is connected with the high-pressure pipe 77, and the detergent can flow into the small pipe 82 through the second pipe 17 and the high-pressure pipe 77. And sprayed into the cleaning chamber 200 through the small pipe 82.

According to an embodiment, the power mechanism 701 is described in detail below. The power mechanism 701 includes a second motor 63 fixed in the upper wall of the power chamber 700. A power connection is provided on the second motor 63. Two power shafts 36. A hollow shaft 69 that can slide up and down is sleeved at the lower end of the second power shaft 36. The hollow shaft 69 and the second power shaft 36 are connected by a spline, and the hollow shaft 69 is fixed on the hollow shaft 69. There is a sliding gear 68, and a magnetic slider 66 that can slide up and down is connected to the left end of the sliding gear 68. A connecting spring 65 is fixed to the upper end of the magnetic slider 66, and an electromagnet 64 is fixed to the upper end of the connecting spring 65. A first connecting gear 71 is fixed at the lower end of the hollow shaft 69, a first transmission shaft 73 is rotatably provided in the lower wall of the power chamber 700, and a second connecting gear 72 is fixed on the first transmission shaft 73 The second connection gear 72 may be meshed with the first connection gear 71. When the second motor 63 is activated, the second motor 63 drives the second power shaft 36 to rotate, and the second power The shaft 36 drives the hollow shaft 69 to rotate, and the hollow shaft 69 drives the sliding The wheel 68 and the first connecting gear 71 rotate, and at this time, the electromagnet 64 is energized, and the electromagnet 64 repels the magnetic slider 66, so that the magnetic slider 66 slides downward, and the magnetic slide The block 66 drives the sliding gear 68 to slide downward, so that the sliding gear 68 drives the hollow shaft 69 and the first connection gear 71 to slide downward, and the first connection gear 71 and the second connection gear 72 meshes, and the first connection gear 71 can drive the first transmission shaft 73 to rotate through the second connection gear 72.

According to an embodiment, the transmission mechanism 401 will be described in detail below. The transmission mechanism 401 includes a first transmission gear 74 provided in the transmission cavity 400, and the first transmission gear 74 is fixed to the shaft center. On the first transmission shaft 73, a lower end of the first transmission gear 74 is meshed with a second transmission gear 75. The left end of the second transmission gear 75 is connected to the lifting mechanism 301. When the first transmission shaft 73 rotates, At this time, the first transmission shaft 73 can drive the lifting mechanism 301 through the first transmission gear 74 and the second transmission gear 75, and a third transmission gear 35 is fixed at the lower end of the first transmission shaft 73. A fourth transmission gear 32 is meshedly connected to the lower end of the third transmission gear 35, and a second transmission shaft 34 is fixed on the axis of the fourth transmission gear 32. The second transmission shaft 34 is rotatably disposed on the fourth transmission gear 32. In the front and rear walls of the transmission cavity 400, a first pulley 33 is fixed on the second transmission shaft 34, and a first belt 31 is connected to the first pulley 33. The left end of the first belt 31 is connected to the drainage control. The mechanism 601 is connected, and when the first transmission shaft 73 rotates, the The first transmission shaft 73 drives the second transmission shaft 34 through the third transmission gear 35 and the fourth transmission gear 32, and the second transmission shaft 34 passes the first pulley 33 and the first transmission shaft 34. The belt 31 can drive the drainage control mechanism 601.

According to an embodiment, the lifting mechanism 301 is described in detail below. The lifting mechanism 301 includes a screw 29 rotatably provided in the left and right walls of the lifting cavity 300. The screw 29 is provided with an opposite rotation direction. A set of threads is provided with a slidable screw slider 21 on the left and right sides of the screw 29. The screw slider 21 and the screw 29 are connected by threads. The upper end of the screw slider 21 is provided with a rotatable central connection. The lower end of the central link 23 is articulated with the screw slider 21 through a first articulation shaft 22, and a support slider 26 is symmetrically arranged in the lifting cavity 300 on both sides, and the support slider 26 and the The top end of the central link 23 is articulated by a second articulation shaft 25, and the central link 23 is articulated by a third articulation shaft 24. The support slider 26 is symmetrically provided with a rotatable pulley shaft 27. A pulley 28 is fixed on the pulley shaft 27. The upper end of the pulley 28 is provided with a bearing plate 84. The bearing plate 84 can carry electronic components. When the screw 29 rotates, the screw slider 21 can be driven to face each other. Or sliding apart, the screw slider 21 passes the first hinge The shaft 22 drives the central link 23 to rotate, and the central link 23 drives the support slider 26 to slide in the lifting cavity 300 through the second hinge shaft 25, and the support slider 26 further passes through the The pulley shaft 27 and the pulley 28 drive the carrier plate 84 to slide upward or downward, and then can drive the electronic component to slide upward or downward.

According to an embodiment, the drainage control mechanism 601 is described in detail below. The drainage control mechanism 601 includes a drainage shaft 62 rotatably provided in the front and rear walls of the drainage control cavity 600, and the drainage shaft 62 is fixedly mounted on the drainage shaft 62. A second pulley 61 is connected to the left end of the first belt 31. A drainage control gear 59 is fixed on the drainage shaft 62. The drainage control gear 59 is located behind the second pulley 61. At the left end, a drainage baffle 58 is engaged with the left end of the drainage control gear 59, and the drainage baffle 58 can close the drainage pipe 19. When the first belt 31 drives the drainage through the second pulley 61 The shaft 62 rotates, the drainage shaft 62 drives the drainage control gear 59 to rotate, the drainage control gear 59 drives the drainage baffle 58 to slide downward, and the drainage baffle 58 can open the drainage pipe 19, The cleaning agent in the lifting chamber 300 can flow out of the device through the drainage pipe 19.

According to an embodiment, the ultrasonic mechanism 501 is described in detail below. The ultrasonic mechanism 501 includes a rotating shaft 38 rotatably provided in the right wall of the ultrasonic mechanism cavity 500. The rotating shaft 38 is provided with a first shaft. A gear 39, a second gear 37 is engaged with the lower end of the first gear 39, the lower end of the second gear 37 is fixed on the second power shaft 36, and an ultrasonic generator is fixed on the left end of the rotating shaft 38 A resonance plate 42 is fixed at the left end of the ultrasonic generator 41, and when the second power shaft 36 rotates, the second power shaft 36 is driven by the second gear 37 and the first gear 39 The rotating shaft 38 rotates, and the rotating shaft 38 can further drive the ultrasonic generator 41. The ultrasonic generator 41 can emit ultrasonic waves, thereby driving the resonance plate 42 to vibrate, and the resonance plate 42 can further drive cleaning The agent vibrates so that the cleaner can ultrasonically clean the electronic components.

The following describes the steps of using an ultrasonic electronic component cleaning device in detail in conjunction with FIG. 1 to FIG. 6:

When ultrasonic cleaning of electronic components is required, the first motor 12 is started, the first motor 12 drives the first power shaft 13 to rotate, and the first power shaft 13 passes the first bevel gear 52 and The second bevel gear 53 drives the first positioning shaft 55 to rotate, the first positioning shaft 55 drives the first link 51 to rotate, and the first link 51 is further passed through the second positioning shaft 48 Drive the large slider 47 to slide in the second link 46, so that the second link 46 rotates about the third positioning shaft 49, and the second link 46 passes the fourth positioning The shaft 45, the third link 43, and the fifth positioning shaft 44 drive the cover plate 14 to slide toward the side close to the first motor 12, thereby opening the cleaning chamber 200. Put it on the upper end of the carrier plate 84, at this time, reverse the first motor 12, so that the cover plate 14 slides to the side away from the first motor 12, and then close the cleaning chamber 200, then close The first motor 12 starts the high-pressure pump 16, and the high-pressure pump 16 transfers the cleaning agent in the cleaning agent storage chamber 18. Pumped into the high-pressure valve 57 through the first pipeline 15 and the second pipeline 17, at this time, the high-pressure valve electromagnet 78 is activated, and the high-pressure valve electromagnet 78 can generate suction to attract the The high-pressure valve slider 81 slides to the left, so that the small pipe 82 is connected with the high-pressure pipe 77, and the detergent can flow into the small pipe 82 through the second pipe 17 and the high-pressure pipe 77 And sprayed into the cleaning chamber 200 through the small pipe 82. When the liquid level of the cleaning agent is highly submerged by the electronic components, the high-pressure pump 16 is turned off, the second motor 63 is started, and the second motor 63 is Drive the second power shaft 36 to rotate, the second power shaft 36 drives the rotation shaft 38 to rotate through the second gear 37 and the first gear 39, and the rotation shaft 38 can further drive the ultrasonic wave The generator 41, the ultrasonic generator 41 can emit ultrasonic waves, thereby driving the resonance plate 42 to vibrate, and the resonance plate 42 can further drive the cleaning agent to vibrate, so that the cleaning agent can perform ultrasonic cleaning on the electronic components. To energize the electromagnet 64, the electromagnet 64 The magnetic slider 66 is repelled, so that the magnetic slider 66 slides downward, the magnetic slider 66 drives the sliding gear 68 to slide downward, so that the sliding gear 68 drives the hollow shaft 69 and the The first connection gear 71 slides down, the first connection gear 71 meshes with the second connection gear 72, and the first connection gear 71 drives the first transmission shaft 73 through the second connection gear 72 Turning, the first transmission shaft 73 drives the second transmission shaft 34 to rotate through the third transmission gear 35 and the fourth transmission gear 32, and the second transmission shaft 34 passes through the first pulley 33, The first belt 31 and the second pulley 61 drive the drainage shaft 62 to rotate, the drainage shaft 62 rotates the drainage control gear 59, and the drainage control gear 59 drives the drainage baffle 58 downward. Slide, and the drainage baffle 58 can open the drainage pipe 19, so that the cleaning agent in the lifting chamber 300 can flow out of the device through the drainage pipe 19, and at the same time, the first transmission shaft 73 passes through the first A transmission gear 74 and the second transmission The wheel 75 drives the screw 29 to rotate, and the screw 29 drives the screw slider 21 to slide toward each other. The screw slider 21 drives the central link 23 to rotate through the first hinge shaft 22, and the central connection The rod 23 drives the support slider 26 to slide toward each other in the lifting cavity 300 through the second hinge shaft 25, and the support slider 26 further drives the bearing plate through the pulley shaft 27 and the pulley 28 84 slides upwards, and then drives the electronic components to slide upwards. At this time, the first motor 12 is started again, so that the cover plate 14 is slid toward the side close to the first motor 12 to open the cleaning chamber 200 so that operation A person can remove the cleaned electronic components from the cleaning chamber 200.

The beneficial effects of the present invention are: the structure of the present invention is simple, the maintenance is convenient, and the use is convenient. The device uses an ultrasonic sounding device to enable the cleaning agent to perform all-round and dead-end cleaning of electronic components through high-frequency vibration, thereby greatly improving cleaning efficiency. Improve the cleaning effect, and will not have any negative impact on electronic components, it is worth industrialization promotion.

The above are only specific embodiments of the invention, but the scope of protection of the invention is not limited to this. Any changes or substitutions that are not thought through without creative work should be covered by the scope of protection of the invention. Therefore, the protection scope of the invention shall be subject to the protection scope defined by the claims.

1. An ultrasonic electronic component cleaning device of the present invention includes the cleaning box, the cleaning box is provided with a cleaning chamber, a cover chamber is provided in the top wall of the cleaning box, and the left and right sides of the top wall of the cover chamber are left and right. Cover plate mechanism is symmetrical; a lifting chamber is connected in the lower wall of the cleaning chamber, a lifting mechanism is provided in the lifting chamber, a spraying mechanism is provided in the left wall of the lifting chamber, and a power chamber is provided in the right wall of the lifting chamber. A power mechanism is provided in the cavity, and a transmission cavity is provided in the lower wall of the power cavity. A transmission mechanism is provided in the transmission cavity, and the transmission mechanism is connected to the power mechanism; a drainage pipe is provided in the left wall of the cleaning box, and the right end of the drainage pipe is in communication with the lifting chamber. a drainage control chamber is provided in the lower wall of the cleaning box, and a drainage control mechanism is provided in the drainage control chamber. The right end of the drainage control mechanism is connected to the transmission mechanism, the right end of the lifting mechanism is connected to the transmission mechanism, an ultrasonic mechanism cavity is provided in the upper wall of the power cavity, and an ultrasonic mechanism is provided in the ultrasonic mechanism cavity.

2. The ultrasonic electronic component cleaning device according to claim 1, wherein the cover mechanism includes a first motor fixedly installed in the cover cavity, and the first motor is close to the cleaning cavity. A first power shaft is power-connected at one end, and a first bevel gear is fixed at one end of the first power shaft near the cleaning cavity. A second bevel gear is meshed with the first bevel gear, and the second The bevel gear shaft is fixedly provided with a first positioning shaft, the first positioning shaft is rotatably provided in the front and rear walls of the cover cavity, and the first positioning shaft is fixed with a rotatable first link. The lower end of the first link is provided with a rotatable second positioning shaft. A large slider is fixed on the second positioning shaft. The cover cavity is provided with a rotatable second link. Two links are hinged in the lower wall of the cover cavity through a third positioning shaft, the large slider can slide in the second link, and a third link is provided at the upper end of the second link. The third link is hinged to the upper end of the second link through a fourth positioning axis, and the third link is near one end of the device center. A cover plate is provided, and the cover plate is hinged to the third link through a fifth positioning shaft.

3. The ultrasonic electronic component cleaning device according to claim 1, wherein the spraying mechanism comprises a high-pressure pump fixedly installed in the left wall of the cleaning box, and a first tube is connected to the left end of the high-pressure pump. The lower end of the first pipeline is connected with a detergent storage cavity, and the detergent storage chamber can store the detergent. The right end of the high-pressure pump is connected with a second pipeline, and the right end is symmetrically arranged up and down. High pressure valve.

4. The ultrasonic electronic component cleaning device according to claim 3, wherein the high-pressure valve is provided with a high-pressure pipeline, and the left end of the high-pressure pipeline is in communication with the second pipeline, and the high-pressure valve There is a slider cavity therein. A high pressure valve electromagnet is fixed on the left wall of the slider cavity. A high pressure valve spring is fixed on the right end of the high pressure valve electromagnet. A high pressure valve slider is fixed on the right end of the high pressure valve spring. A small pipeline is provided in the high-pressure valve slider, and the high-pressure valve slider can slide left and right in the slider cavity.

5. The ultrasonic electronic component cleaning device according to claim 1, wherein the power mechanism comprises a second motor fixedly installed in the upper wall of the power cavity, and the second motor is provided with a power connection. A second power shaft, a hollow shaft slidable up and down is sleeved at the lower end of the second power shaft, the hollow shaft and the second power shaft are connected by a spline, and a sliding gear is fixed on the hollow shaft. A magnetic slider capable of sliding up and down is connected to the left end of the sliding gear, a connection spring is fixed to the upper end of the magnetic slider, an electromagnet is fixed to the upper end of the connection spring, and a first connection gear is fixed to the lower end of the hollow shaft. A first transmission shaft is rotatably provided in the lower wall of the power chamber, and a second connection gear is fixed on the first transmission shaft, and the second connection gear can be meshed with the first connection gear.

6. The ultrasonic electronic component cleaning device according to claim 5, wherein the transmission mechanism includes a first transmission gear provided in the transmission cavity, and the first transmission gear is fixedly disposed at the center of the shaft. On the first transmission shaft, a lower end of the first transmission gear is meshed with a second transmission gear, and a left end of the second transmission gear is connected to the lifting mechanism; a third transmission gear is fixed at the lower end of the first transmission shaft, a fourth transmission gear is engaged with the lower end of the third transmission gear, and a second transmission shaft is fixed at the center of the fourth transmission gear. Two transmission shafts are rotatably provided in the front and rear walls of the transmission cavity. A first belt pulley is fixed on the second transmission shaft. A first belt is connected to the first belt pulley. The drainage control mechanism is connected.

7. The ultrasonic electronic component cleaning device according to claim 6, characterized in that the lifting mechanism comprises rotatably provided screws in the left and right walls of the lifting cavity, and the screws are provided with opposite rotation directions. A set of threads. The screw is provided with a slidable screw slider on the left and right sides. The screw slider is connected to the screw by a screw. The upper end of the screw slider is provided with a rotatable central link. The lower end of the central link is hinged to the screw slider through a first hinge axis, and support sliders are symmetrically arranged in the lifting cavity left and right, and the support slider and the top end of the central link are hinged to each other through a second hinge axis. The central link is hinged by a third hinge shaft. The support slider is provided with a rotatable pulley shaft symmetrically on the left and right sides. The pulley shaft is fixed on the pulley shaft. The upper end of the pulley is provided with a bearing plate.

8. The ultrasonic electronic component cleaning device according to claim 7, wherein the drainage control mechanism comprises a drainage shaft rotatably provided in the front and rear walls of the drainage control cavity, and the drainage shaft is fixedly mounted on the drainage shaft. There is a second pulley, the second pulley is connected to the left end of the first belt, a drainage control gear is fixed on the drainage shaft, the drainage control gear is located at the rear end of the second pulley, and the drainage control gear A drainage baffle is provided at the left end of the meshing connection.

9. The ultrasonic electronic component cleaning device according to claim 5, wherein the ultrasonic mechanism comprises a rotating shaft rotatably provided in a right wall of the cavity of the ultrasonic mechanism, and the rotating shaft is fixedly disposed on the rotating shaft. A first gear, a second gear being meshedly connected to a lower end of the first gear, a lower end of the second gear fixed to the second power shaft, and an ultrasonic generator fixed to a left end of the rotating shaft, the ultrasonic wave A resonance plate is fixed on the left end of the generator.
